(19) United States
(12) Patent Application Publication
(10) Pub. No.: US 2015/0007426 A1
(43) Pub. Date: Jan. 8, 2015

(54) ARCHIMEDEAN SCREW

(71) Applicant: WAM INDUSTRIALE S.p.A., Modena (IT)

(72) Inventor: Vainer Marchesini, San Prospero (IT)

(21) Appl. No.: 14/493,838

(22) Filed: Sep. 23, 2014

Related U.S. Application Data
(63) Continuation of application No. 13/498,439, filed on May 29, 2012.

(30) Foreign Application Priority Data
Sep. 28, 2009 (IT) BO2009A000620

(51) Int. Cl. B21D 53/24; B65G 33/26

(52) U.S. Cl. CPC B21D 53/24; B65G 33/26
USPC 29/456; 228/173.1

(57) ABSTRACT

An Archimedean screw comprising a spiral helix. The Archimedean screw is characterized in that it further comprises a central element plastically twisted like a helix about a central symmetry axis. The spiral helix, in turn, is wound about the central element. Furthermore, the central element is the only supporting element of itself and of said spiral helix.

### CROSS REFERENCE TO RELATED APPLICATIONS

The present application is a continuation of U.S. patent application Ser. No. 13/498,439, filed Mar. 27, 2012, which is a U.S. National Phase of International Patent Application PCT/IB2010/002412, filed Sep. 27, 2010, which claims priority to Italian Patent Application No. B02009A000620 filed Sep. 28, 2009, each of which is incorporated herein by reference in its entirety.

### TECHNICAL FIELD

The present invention relates to an improved Archimedean screw.

### BACKGROUND ART

It is known that Archimedean screws are substantially capable of moving, in particular lifting, liquid material, sand, gravel, crushed stones, in granular or powder form, to be dumped into an unloading station.

The Archimedean screws known today comprise a spiral helix, which may be wound about a substantially cylindrical central shaft or not. The spiral may be integral with the central shaft or not.

However, the Archimedean screws comprising a central shaft may display the disadvantage that at least one portion of the material to be conveyed sticks to the cylindrical wall of the central shaft without therefore being subjected to the pushing action of the spiral helix, and therefore without being dumped into the unloading station.

In other words, the existence of cylindrical segments of the supporting shaft on which portions of the material to be conveyed are deposited implies the risk that such portions stop on such cylindrical segments also during the rotation of the cylindrical shaft, without such portions being actually fed towards the product unloading station. This is obviously detrimental to efficiency of the Archimedean screw conveyor.

Such an issue may imply disadvantages of various types:
frequent interruptions of the Archimedean screw conveyor and equal number of interventions by personnel to clean the Archimedean screw itself, with obvious consequences from the point of view of production;
increase of conveyor input power, which consequently causes an appreciable increase of management costs and a decrease of conveying efficiency of the machine; and
uncontrolled increase of mechanical stress to which the Archimedean screw is subjected, which may even cause a structural collapse of the conveyor.

### DISCLOSURE OF INVENTION

It is thus the object of the present invention to make an improved Archimedean screw, the technical features of which are such to avoid the problems of the prior art illustrated above.

It is thus the object of the present invention an Archimedean screw constituted by a spiral helix within which a twisted plate is used instead of the inner shaft. Therefore, in the present invention, the twisted central plate performs both the function of structural supporting element of the Archimedean screw, instead of the usual cylindrical shaft, and a further pushing action on the granular material to be conveyed.

Preferably, but not necessarily said spiral helix is integral with said twisted plate. The twisted plate is positioned inside the spiral helix, within the space circumscribed by the inner diameter of the latter towards the longitudinal axis, which therefore is also conventionally recognized as rotation axis. The two components—the twisted plate and the spiral helix—have their respective longitudinal axes in coinciding position.

It has be experimentally found that the twisted plate may perform its function either remaining stationary with respect to the spiral helix, or moving with respect thereto about the longitudinal axis, coinciding with that of the spiral helix. This relative rotary motion of the twisted plate about the spiral helix may occur in either direction, and may mean that either the twisted plate remains stationary while the spiral helix is moving, or that the spiral helix remains stationary when the twisted plate is moving, or that both move with constantly rotary motions about the respective longitudinal axes (which coincide), but of module and sign totally independent from each another.

The outer spiral helix is a typical helicoid described exhaustively by the fundamental parameters of all helicoids, which are substantially the following:
outer diameter;
inner diameter;
pitch;
thickness of materials; and
direction of winding.

Some of these parameters (pitch, diameter and thickness) may be either constant along the axis of the helix or variable, as always occurs for the construction of these devices.

The twisted plate, in turn, is obtained from a rectangular section bar, preferably but not necessarily of metal, which is twisted by applying when cold a mechanical twisting stress about the longitudinal axis of the bar itself, passing through the centre of its section. Opposite winding directions are obtained by applying such a stress in either one direction or the other.

Assuming that the rectangular section of the bar has a h/b ratio equal to zero, i.e. the rectangle is ideally a segment, each of the two edges of the twisted bar will draw a cylindrical helix with a given pitch and a given diameter, equal to one another, in space. The surface thus obtained is defined in geometry with the name “helicoid”.

In actual fact, the h/b ratio of the rectangular section of the original bar of the twisted plate is always low, but never zero. The height of the rectangle, which is the section of the original bar, constitutes the thickness of the helical profile of the twisted plate.

The pitch and the diameter may be controlled to be either constant or variable along the axis of the helicoid, as occurs for making spiral helixes.

Two elements with profiles joined to one another are obtained by making the diameter and the pitch of the helix generated by each of the two edges of the twisted plate correspond with the diameter and the pitch of the inside of the spiral helix.

The thicknesses of the spiral helixes and of the twisted plate may be either different or equal to one another. If they are different, the thickness of the twisted plate is always lower with respect to that of the spiral helix, and the relative positioning of the two components is always obtained by making the surfaces of the side on which the material is pushed correspond so as to reduce the risk of creating recesses in which the conveyed material may be deposited giving rise to residues.

The two components, after having been coupled and made integral to each another, give rise to an Archimedean screw which differs from the others because it is free from the traditional cylindrical inner tube, but which has, in all cases, a closed projection of the front section. This is obtained by exploiting only one of the twisted plate threads, while the other remains exposed, giving rise to a geometry capable of effectively contributing to the conveying functionality of the Archimedean screw.

The coupling between the outer spiral helix and the inner twisted plate may be obtained in various manners, also according to the type of material used to make the entire Archimedean screw. Continuous or intermittent welding may be used, according to the specifications of use required for the Archimedean screw in order to make the two components integral. Coupling and/or bolting solutions are also possible. The latter allow to couple a spiral helix with a twisted plate made of even completely different materials.

The Archimedean screw thus obtained is improved due to its geometric shape which allows enhancing the potentials of the outer spiral helix, compensating the most evident shortcomings by virtue of the contribution provided by the twisted plate inserted therein.

The Archimedean screw may be made of different materials. The most common are metal materials, such as traditional or high-strength steel, stainless steel or alloyed steel. Solutions using non-metallic or plastic material are also possible, or any other material which allows to make both the spiral helix and the twisted plate using the available production technologies. The twisted plate does not necessarily need to be made with the same material as the spiral helix, because it is simply sufficient for the two components to be coupled according to the contemplated methods. Very common are also Archimedean screws made of steel and coated with a plastic material, such as polyurethane resins. In this case, curing may be carried out either before or after coupling between the spiral helix and the twisted plate, according to the coupling method used.

The rotation motion is transmitted to the Archimedean screw by means of a mechanical coupling member. The prior art offers various types, and all are compatible with the Archimedean screw object of the invention.

Worth noting is also the fastening method of the coupling to the spiral helix and the twisted plate, now forming an integral whole. The body of the coupling is made integral with both the spiral helix and the twisted plate, by means of a fixed or direct method. In this manner, the motion transmitted by the drive is conveyed to the coupling both on the spiral helix and on the twisted plate being distributed thereon in different percentages.

### BRIEF DESCRIPTION OF THE DRAWINGS

For a better understanding of the invention, an embodiment is described by way of non-limitative example, with the aid of the accompanying drawings, in which:

FIG. 1 is a perspective view of a preferred embodiment of the Archimedean screw object of the present invention;

FIG. 2 is a section view of the Archimedean screw in FIG. 1; and

FIG. 3 is a side view of the Archimedean screw in FIG. 1.

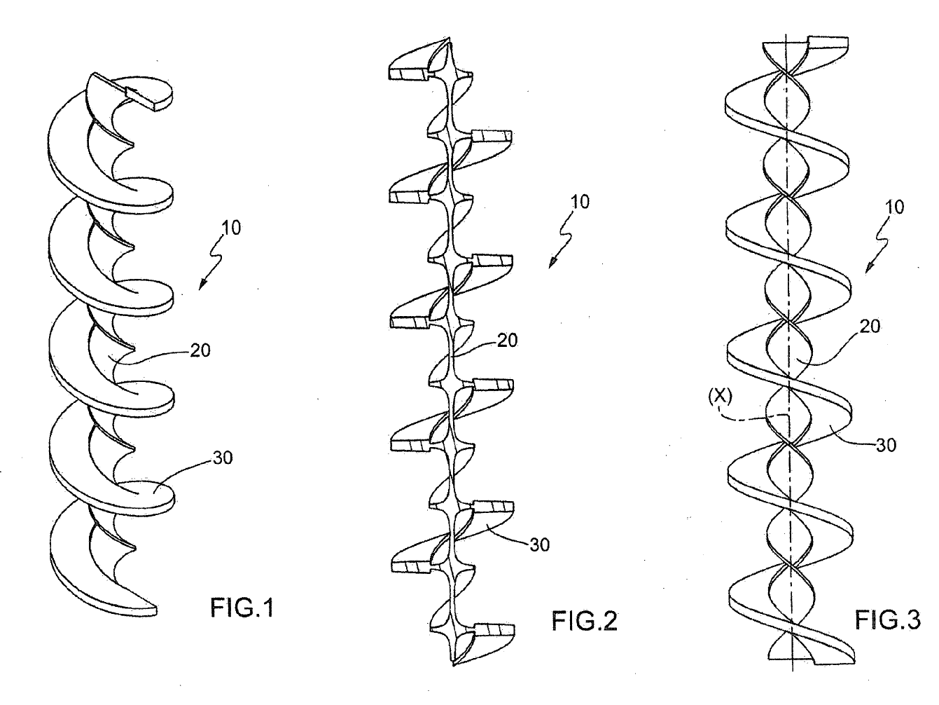

### BEST MODE FOR CARRYING OUT THE INVENTION

In the accompanying figures, numeral 10 indicates as a whole a preferred embodiment of the Archimedean screw object of the present invention.

The Archimedean screw 10 comprises a central element 20, preferably obtained from a rectangular strap plastically twisted like a helix about a central symmetry axis (X) (FIG. 3), and a spiral helix 30 wound about the central element 20, with which it may be integral.

As shown in the accompanying figures, the central element 20 has twice the number of threads with respect to the number of threads of the spiral helix 30.

As apparent to a person skilled in the art, the spiral helix 30 may be fixed to the central element 20 also by means of welding, or by means of other fastening means, and the pitch thereof may be different from that described above.

In this manner, the Archimedean screw object of the present invention avoids the drawbacks of the prior art. Indeed, the spiral configuration of the central element 20 continuously breaks the so-called “material build-up”, consequently preventing the material particles from sticking to the central element without being unloaded to the end of the Archimedean screw. Furthermore, the lack of a cylindrical central tubular supporting element does not give rise to deposits of granular or powder material on cylindrical portions of the tubular element itself, as instead occurs in the systems made until now.

As mentioned, the Archimedean screw 10 comprises two single elements (the central element 20 and the spiral helix 30) made of metallic material joined to one another, e.g. by intermittent electric welding.

The various elements are thus obtained:

(1) Central Element 20:

The starting point is a rectangular section metal strap. One end of the strap is blocked and fixed, while the other end is blocked onto a turning head which imposes a rotation to the strap itself about the longitudinal axis passing exactly through the centre of its section. Furthermore, the ends of the strap are kept constantly pulled. The rotation of one end and the traction impose a cold plastic deformation to the strap such as to transform the strap into a two-thread helix.

(2) Spiral Helix 30:

The starting point is a metallic rectangular section bar, one end of which is blocked on a rotating head. Such a rotating head is integral with a die (cylindrical shaft), which will thus also rotate, the die is then supported on the opposite end by a tailstock. The starting position of the metallic bar is tangent to the die with the shorter side of the rectangular section of the bar and an inclination of the bar which respect to the die axis equal to at least half of the angle of the helix to be obtained. Furthermore, thus positioned, the rectangular bar is guided and rests on idle rollers, which by turning the rotary head and thus the die, form a reaction on the rectangular bar so that it can be wound on the die. The idle rollers are mounted on a carriage which moves longitudinally in controlled manner with respect to the rotation to determine the pitch of the spiral. Thus the rotation of the head combined with the feeding of the carriage impose a plastic deformation to the rectangular bar wound about the matrix to thus obtain a spiral.

(3) Archimedean Screw 10:

The central two-thread element 20 has the pitch of one thread equal to the pitch of the outer spiral to be joined; the central element 20 is inserted in the spiral helix 30 making one principle mate with the outer spiral and thus welding the outside of the thread of the central element 20 and the inside of the spiral helix 30 to join two bodies.

The present invention further relates to a conveyor system (not shown) which uses Archimedean screws of the type described above, Archimedean screws which are arranged in series with respect to one another.

Indeed, when the Archimedean screw is very long undesired bending phenomena of the same may occur due to its weight.

For this purpose, the first Archimedean screw should end with a cylindrical segment firstly supported by a socket which discharges the total weight onto the wall of the outer containment tube. A second Archimedean screw also provided with a similar cylindrical segment should discharge its weight on a second socket support, and so on to cover the entire length of the conveyor system.

The main advantage of the Archimedean screw object of the present invention consists in the absence of central cylindrical segments on which build-ups of granular or powder material are formed, the removal of which is very difficult, or even impossible, without temporarily stopping the entire system. Indeed, in the present case, the central element, in addition to performing the function of supporting the outer spiral helix, by virtue of its spiral shape brakes the build-ups of material which may be progressively formed within the spiral helix itself. This significantly increases the efficiency of the Archimedean screw, i.e. the unit of material conveyed in the unit of time. Furthermore, the interruption time of the system for cleaning the same is reduced.

1. A method of manufacturing an Archimedean screw comprising the step of:
wrapping a spiral helix part about a central element which is a separate part relative to the spiral helix part, wherein the central element is plastically twisted like a helix about a central symmetry axis and the central element is the only supporting element of itself and of the spiral helix part and the Archimedean screw is formed.

2. The method of claim 1, wherein the central element has twice the number of threads with respect to those of the spiral helix part.

3. The method of claim 1, wherein a thickness of the spiral helix part is different from a thickness of the central element.

4. The method of claim 3, wherein the thickness of the central element is less than the thickness of the spiral helix part.

5. The method of claim 3, further including the step of positioning the central element with respect to the spiral helix part by making surfaces on a side on which the material is pushed correspond so as to reduce a risk of creating recesses in which conveyed material may deposit giving rise to residues.

6. The method of claim 1, wherein the step of wrapping the spiral helix part about the central element results in coupling therebeween so as to form a conveying device that has a closed projection of a front section thereof.

7. The method of claim 1, further including the step of providing the spiral helix part and the central element with the same rotational speed as regard to both module and to sign.

8. The method of claim 1, further including providing the spiral helix part and the central element with a relative rotary motion with respect to one another.

9. The method of claim 8, wherein the central element is fixed, while the spiral helix part has a rotary motion, in each of two directions, with respect to the central element; or in that the spiral helix part is fixed, while the central element has a rotary motion , in each of two directions, with respect to the spiral helix part.

10. The method of claim 8, wherein both the spiral helix part and the central element move with rotary motions about respective longitudinal axes, although with rotational speeds having module and sign independent of each other.

11. The method of claim 1, further including the step of welding the spiral helix part to the central element to form a coupled structure, the welding being of a continuous or intermittent nature.

12. The method of claim 1, further including the step of using at least one of a coupling and a bolting to couple the spiral helix part and the central element.

13. The method of claim 1, wherein the spiral helix part and the central element are made of different materials.

14. The method of claim 1, wherein the central element comprises a two-thread element which has a pitch of one thread equal to a pitch of an outer spiral to be joined and further including the step of inserting the central element in the spiral helix part making one principle mate with the outer spiral, thereby welding an outside of the thread of the central element and an inside of the spiral helix part to join the central element and the spiral helix part.

15. The method of claim 1, wherein after the spiral helix part is wrapped around the central element, the spiral helix part and the central element are subjected to a single curing step.

16. The method of claim 1, further including the step of supporting at least one Archimedean screw.

17. The method of claim 1, further including the step of arranging a plurality of Archimedean screws in series with respect to one another.

18. A method of manufacturing an Archimedean screw comprising the step of:
twisting a body in a helical manner about a central symmetry axis to form a central element; and
wrapping a spiral helix part about the central element so as to couple the spiral helix part to the central element and form the Archimedean screw, wherein the spiral helix part is a separate part relative to the central element and the coupling between the spiral helix part and the central element is such that the central element is the only supporting element of itself and of the spiral helix part.

19. The method of claim 18, wherein a diameter and pitch of a helix generated by each of two edges of the twisted body correspond to a diameter and pitch of an inside of the spiral helix part.

20. The method of claim 18, wherein the step of twisting the body comprises beginning with a rectangular shaped plate and blocking and fixing one end of the plate while an opposite end of blocked onto a turning head which imposes a rotation to the plate itself about a longitudinal axis passing through a center of the plate.

21. The method of claim 18, wherein the helix structure of the central element is formed separate from and prior to wrapping the spiral helix part about the central element and similarly, the helix nature of the spiral helix part is formed separate from and prior to wrapping the spiral helix part about the central element.

22. The method of claim 18, wherein the step of wrapping the spiral helix part about the central element to form the Archimedean screw results in an absence of central cylindrical segments on which build-ups of granular or powder material are formed during use,
